(19) United States
(12) Patent Application Publication
(10) Pub. No.: US 2015/0365810 A1
(43) Pub. Date: Dec. 17, 2015

(54) VEHICULAR EMERGENCY REPORT APPARATUS AND EMERGENCY REPORT SYSTEM

(71) Applicant: DENSO CORPORATION, Kariya-city (JP)

(72) Inventors: ATSUSHI YAMAGUCHI, Nagoya-city (JP); SHINGO WANAMI, Kariya-city (JP)

(21) Appl. No.: 14/736,426

(22) Filed: Jun. 11, 2015

(30) Foreign Application Priority Data
Jun. 13, 2014 (JP) 2014-122593

(51) Int. Cl. H04W 4/22; H04N 7/18; G06K 9/00; B60R 11/04; G06Q 10/10; G06Q 50/26

(52) U.S. Cl. CPC H04W 4/22; G06Q 10/10; G06Q 50/265; G06K 9/00845; B60R 11/04; H04N 7/183

(57) ABSTRACT

A vehicular emergency report apparatus is provided. The vehicular emergency report apparatus includes a report portion reporting to a rescue center when a collision occurs to a vehicle, a collision status detection portion, an occupant condition detection portion, and a report control portion. The report control portion includes a memory portion, a collision pattern determination portion, an occupant condition determination portion, and a rescue information generation portion. An emergency report system includes a rescue center, a report portion reporting to the rescue center when a collision occurs to a vehicle, a collision status detection portion detecting a collision status, an occupant condition detection portion detecting a condition of an occupant after the collision, and a report control portion.

### CROSS REFERENCE TO RELATED APPLICATION

This application is based on Japanese Patent Application No. 2014-122593 filed on Jun. 13, 2014, the disclosure of which is incorporated herein by reference.

### TECHNICAL FIELD

The present disclosure relates to a vehicular emergency report apparatus and an emergency report system performing an emergency report at the time of an emergency such as collision of a vehicle.

### BACKGROUND ART

Patent literature 1: JP 2012-176721 A

Conventionally, a collision determination apparatus determining a collision based on an acceleration generated in a vehicle is known in, for example, patent literature 1. In a collision determination apparatus in a conventional technology, the collision determination apparatus includes a first acceleration sensor and a second acceleration sensor. The first acceleration sensor detects acceleration acting in a length direction and a width direction of a vehicle. The second acceleration sensor detects acceleration acting in the length direction of the vehicle. At the time of a non-malfunction case of the second acceleration sensor, the collision determination apparatus preforms a collision determination based on the acceleration acting in the length direction of the vehicle obtained from the first acceleration sensor and the second acceleration sensor. At the time of a malfunction case of the second acceleration sensor, the collision determination apparatus performs the collision determination based on the acceleration in the length direction and the width direction of the vehicle obtained from the first acceleration sensor. The conventional collision determination apparatus performs the collision determination based on the acceleration generated in the vehicle.

In addition, a vehicular emergency report apparatus that performs a collision determination based on acceleration generated in a vehicle and transmits a result to a rescue center to request rescue is also known. The vehicular emergency report apparatus estimates injury of an occupant based on acceleration generated in a vehicle or based on an image or the like by a camera device. The vehicular emergency report apparatus transmits the result of the estimation to the rescue center. In many cases, a case where a collision in which an airbag device in a vehicle operates has occurred is defined as the time of a report to the rescue center. At the time of the report, predetermined information regarding injury of an occupant is transmitted to the rescue center. The rescue center selects a rescue method based on the received information performs rescue.

The inventors of the present application have found the following. Conventionally, when a vehicular emergency report apparatus estimates injury of an occupant at the time of collision, estimation content may be simple such as an extent of the injury. That is, an idea of the estimation content is as follows. Initially, a line segment having a maximum damage and a minimum damage at the both ends of the like segment is considered, for example. Then, an extent of the injury of the target occupant is indicated on the line segment. Therefore, transmitted information amount regarding injury of an occupant is small amount. It may be difficult for a rescue center receiving request of rescue to consider and determine an order of an occupant to be rescued or a specific method to an occupant before a rescue staff arrives at a field site.

### SUMMARY

It is an object of the present disclosure to provide a vehicular emergency report apparatus that enables to increase information amount transmitted to a rescue center regarding injury of an occupant. It is also an object of the present disclosure to provide an emergency report system that enables to increase information amount transmitted to a rescue center regarding injury of an occupant.

According to one aspect of the present disclosure, a vehicular emergency report apparatus is provided. The vehicular emergency report apparatus includes a report portion reporting to a rescue center when a collision occurs to a vehicle, a collision status detection portion detecting a collision status of the vehicle, an occupant condition detection portion detecting a condition of an occupant in the vehicle after the collision of the vehicle, and a report control portion. The report control portion includes a memory portion, a collision pattern determination portion, an occupant condition determination portion, and a rescue information generation portion. The memory portion stores collision patterns of the vehicle and physical conditions of the occupant after the collision of the vehicle. The collision pattern determination portion selects a collision pattern from the plurality of collision patterns stored in the memory portion based on the collision status of the vehicle detected by the occupant condition detection portion. The occupant condition determination portion selects a physical condition from the plurality of physical conditions stored in the memory portion based on the condition of the occupant detected by the occupant condition detection portion. The rescue information generation portion generates rescue determination information based on a combination of a collision pattern selected by the collision pattern determination portion and a physical condition selected by the occupant condition determination portion. The rescue center uses the rescue determination information to select a rescue content.

According to another aspect of the present disclosure, an emergency report system is provided. The emergency report system includes a rescue center, a report portion, a collision status detection portion, an occupant condition detection portion, and a report control portion. The report portion reports to the rescue center when a collision occurs to a vehicle. The collision status detection portion detects a collision status of the vehicle. The occupant condition detection portion detects a condition of an occupant in the vehicle after the collision of the vehicle. The report control portion includes a memory, a collision pattern determination portion, an occupant condition determination portion, and a rescue information generation portion. The memory portion stores a plurality of collision patterns of the vehicle and a plurality of physical conditions of the occupant after the collision of the vehicle. The collision pattern determination portion selects a collision pattern from the plurality of collision patterns stored in the memory portion based on the collision status of the vehicle detected by the occupant condition detection portion. The occupant condition determination portion selects a physical condition from the plurality of physical conditions stored in the memory portion based on the condition of the occupant detected by the occupant condition detection portion. The rescue information generation portion generates rescue determination information based on a combination of a collision pattern selected by the collision pattern determination portion and a physical condition selected by the occupant condition determination portion, wherein the rescue center uses the rescue determination information to select a rescue content.

According to the vehicular emergency report apparatus and the emergency report system, the emergency report system includes the rescue information generation portion that generates rescue determination information based on a combination of the collision pattern selected by the collision pattern determination portion and the physical condition selected by the occupant condition determination portion. Therefore, it may be possible to increase information amount regarding injury of an occupant in the rescue determination information. The rescue center uses the rescue determination information to select rescue content. Therefore, at the time of collision of a vehicle, it may be possible for the rescue center to consider a more specific rescue method.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram illustrating a vehicle including a vehicular emergency report apparatus and a rescue center according to a first embodiment;

FIG. 2 is a block diagram illustrating the vehicular emergency report apparatus and the rescue center;

FIG. 3A is a diagram illustrating an example of a collision to a center pole;

FIG. 3B is a diagram illustrating an acceleration detected by each acceleration sensor of a vehicle in a center pole collision;

FIG. 3C is a diagram illustrating an example of a head-on collision;

FIG. 3D is a diagram illustrating an acceleration detected by each acceleration sensor of the vehicle in the head-on collision;

FIG. 3E is a diagram illustrating an example of an offset collision;

FIG. 3F is a diagram illustrating an acceleration detected by each acceleration sensor of the vehicle in the offset collision;

FIG. 4 is a flowchart illustrating an emergency report in the first embodiment;

FIG. 5 is a flowchart illustrating a first pattern matching illustrated in FIG. 4;

FIG. 6 is a flowchart illustrating an acceleration pattern matching illustrated in FIG. 5;

FIG. 7 is a flowchart illustrating a front image pattern matching illustrated in FIG. 5;

FIG. 8 is a flowchart illustrating a damage level determination illustrated in FIG. 4;

FIG. 9 is a flowchart illustrating a second pattern matching and a vital indication level illustrated in FIG. 4;

FIG. 10 is a diagram illustrating a matrix representing a survival rate determination result represented on a two-dimensional plane in the first embodiment;

FIG. 11 is a diagram schematically illustrating an effect of the survival rate determination result illustrated in FIG. 10;

FIG. 12 is a diagram illustrating a vehicle mounted with a vehicular emergency report apparatus and a rescue center in a second embodiment;

FIG. 13 is a diagram illustrating a vehicle mounted with a vehicular emergency report apparatus and a rescue center in a third embodiment;

FIG. 14 is a diagram illustrating a matrix illustrating an injury condition determination result illustrated on a two-dimensional plane in another embodiment;

FIG. 15A is a diagram illustrating a relationship between acceleration generated in a vehicle and a severe injury probability;

FIG. 15B is a diagram illustrating an example of a center pole collision;

FIG. 15C is a diagram illustrating an example of a head-on collision;

FIG. 15D is a diagram illustrating an example of an oblique collision;

FIG. 15E is a diagram illustrating an example of an under-ride collision; and

FIG. 15F is a diagram illustrating an example of an offset collision.

### DETAILED DESCRIPTION

### First Embodiment

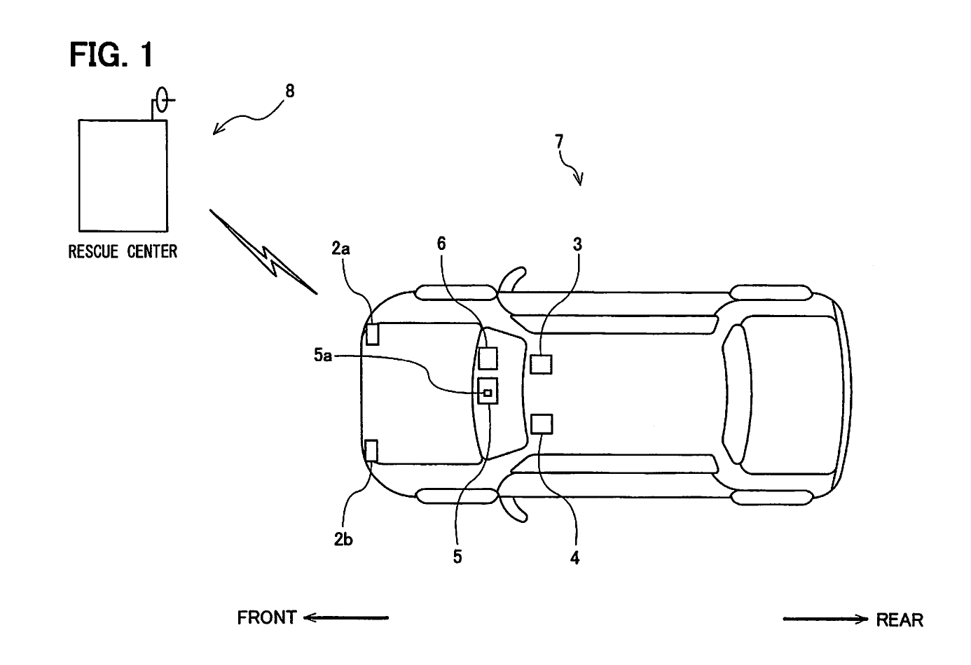

A vehicular emergency report apparatus 1 in a first embodiment will be explained with referring to FIG. 1 to FIG. 11. As illustrated in FIG. 1, a vehicle 7 includes a vehicular emergency report apparatus 1. The vehicle 7 includes a right front acceleration sensor 2a, a left front acceleration sensor 2b, and a floor acceleration sensor 5a. Each of the right front acceleration sensor 2a, the left front acceleration sensor 2b, and the floor acceleration sensor 5a corresponds to a collision status detection portion and a shock detection portion. Hereinafter, the right front acceleration sensor 2a, the left front acceleration sensor 2b, and the floor acceleration sensor 5a may be referred to as acceleration sensors 2a, 2b, 5b. Each of the acceleration sensors 2a, 2b, 5a may be a capacitance type acceleration sensor, a piezoresistance type acceleration sensor, or a heat detection type acceleration sensor.

The right front acceleration sensor 2a and the left front acceleration sensor 2b are respectively provided to right and left portions in a front end part in the vehicle 7. The right front acceleration sensor 2a and the left front acceleration sensor 2b enable to detect acceleration in a front-rear direction in the vehicle 7. The floor acceleration sensor 5a is provided to the inside of a controller 5. The controller 5 is mounted to the lower part in a dashboard in front of a driver's seat, for example. Incidentally, a configuration other than the floor acceleration sensor 5a corresponds to a report control portion. The floor acceleration sensor 5a enables to detect acceleration in the front-rear direction and a right-left direction of the vehicle 7. Incidentally, the floor acceleration sensor 5a may independently include a sensor that enables to detect the acceleration in the right-left direction of the vehicle 7 and another sensor that enables to detect the acceleration in the front-rear direction of the vehicle 7. The front-rear direction in a vehicle may also be referred to as a length direction in a vehicle, and the right-left direction in a vehicle may also be referred to as a width direction in a vehicle. The acceleration sensors 2a, 2b, 5a enable to detect a shock applied to each part (or each sensor) of the vehicle 7 from the outside of the vehicle 7 at the time of an accident or the like. That is, the acceleration sensors 2a, 2b, 5a enable to detect a collision status of the vehicle 7. Incidentally, in order to detect the shock applied to each part of the vehicle 7 from the outside, an acceleration sensor or a pressure sensor may be provided to the inside of a door of the vehicle 7 or the like in addition to the acceleration sensors 2a, 2b, 5a.

As illustrated in FIG. 1, a cabin of the vehicle 7 has a front photographing camera 3. The front photographing camera 3 corresponds to a collision status detection portion and a vehicle exterior photographing device. The front photographing camera 3 enables to photograph a front part of the vehicle 7 for detecting a collision status of the vehicle 7. The front photographing camera 3 is a CCD camera, for example. The front photographing camera 3 is not limited to a CCD camera. The front photographing camera 3 may be a CMOS (complementary metal oxide semiconductor) camera, a MOS (metal oxide semiconductor) camera, an infrared camera, or the like.

The vehicle 7 includes a cabin camera 4. The cabin camera 4 corresponds to an occupant condition detection portion and a cabin camera device. The cabin camera 4 is provided to a ceiling of the vehicle 7. The cabin camera 4 photographs a condition of an occupant in the cabin. The cabin may also be referred to as an inside of the vehicle. The cabin camera 4 photographs the condition of the occupant in the vehicle 7 after collision of the vehicle 7. In the present embodiment, the cabin camera 4 is a CCD camera, for example. The cabin camera 4 is not limited to the CCD camera. The cabin camera 4 may be a CMOS camera, a MOS camera, an infrared camera, or the like.

The vehicle 7 includes a communication unit 6. The communication unit 6 corresponds to a report portion. In the present embodiment, the communication unit 6 is a data communication module (DCM), for example. The communication unit 6 is not limited to the DCM. The communication unit 6 may be a mobile or the like. The communication unit 6 performs a report to a rescue center 8 based on a signal from the controller 5 in a case where the collision occurs to the vehicle 7.

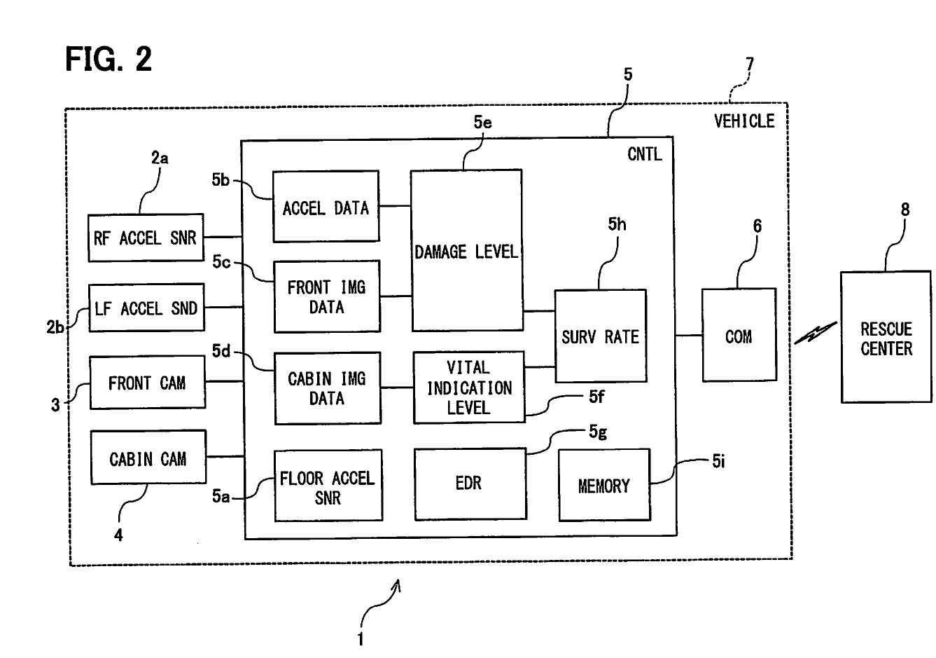

The controller 5 illustrated in FIG. 2 corresponds to a control device that includes the floor acceleration sensor 5a, an input/output device, a CPU, a RAM (not shown), or the like. The controller 5 is connected with the right front acceleration sensor 2a, the left front acceleration sensor 2b, the front photographing camera 3, the cabin camera 4, and the communication unit 6.

As a configuration other than the floor acceleration sensor 5a, the controller 5 includes an acceleration data classification portion 5b, a front image data classification portion 5c, a cabin image data classification portion 5d, a damage level determination portion 5e, a vital indication level determination portion 5f, a EDR portion 5g, a survival rate determination portion 5h, and a pattern memory portion 5i. The controller 5 may be used as an airbag ECU of the vehicle 7.

The acceleration data classification portion 5b corresponds to a shock classification portion. The acceleration data classification portion 5b performs an acceleration pattern matching based on a shock (an acceleration data) applied to the vehicle 7. The acceleration sensors 2a, 2b, 5a detect the shock. The acceleration data classification portion 5b identifies a collision status of the vehicle 7. The acceleration data classification portion 5b classifies the collision status into one of patterns stored in the pattern memory portion 5i, so that the acceleration data classification portion 5b generates a first collision classification.

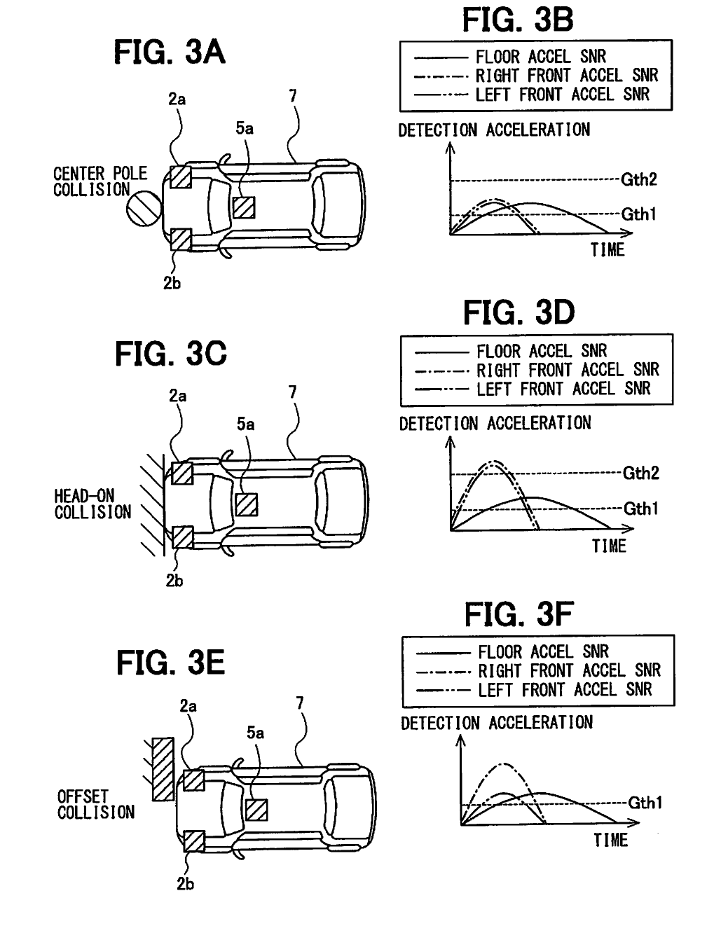

Hereinafter, based on FIG. 3A to FIG. 3F, a method of the acceleration pattern matching by the acceleration data classification portion 5b will be explained. As illustrated in FIG. 3A to FIG. 3F, the acceleration data classification portion 5b determines that a collision has occurred in the vehicle 7 in a case where the floor acceleration sensor 5a has detected acceleration greater than a first acceleration threshold GTh1. Incidentally, the acceleration data classification portion 5b may determine that the collision has occurred in the vehicle 7 based on a signal from another airbag ECU. Incidentally, in FIG. 3B, FIG. 3D, and FIG. 3F, a solid line represents a data of a floor acceleration sensor, a single dot chain represents a data of a right front acceleration sensor, and a double dot chain represent a data of a left front acceleration sensor.

As illustrated in FIG. 3C and FIG. 3D, the acceleration data classification portion 5b determines that a head-on collision occurs to the vehicle 7 when a collision has occurred in the vehicle 7 and the both of the right front acceleration sensor 2a and the left front acceleration sensor 2b have detected acceleration greater than a second acceleration threshold GTh2.

As illustrated in FIG. 3E and FIG. 3F, the acceleration data classification portion 5b determines that an offset collision occurs to the vehicle 7 when a collision has occurred in the vehicle 7 and a difference between detection values by the right front acceleration sensor 2a and the left front acceleration sensor 2b is greater than a predetermined threshold value.

As illustrated in FIG. 3A and FIG. 3B, the acceleration data classification portion 5b determines that a center pole collision (or a road pylon collision) occurs to the vehicle 7 when a collision has occurred in the vehicle 7 and it is not determined that the head-on collision occurs and it is not determined that the offset collision occurs to the vehicle 7.

The front image data classification portion 5c corresponds to a vehicle exterior image classification portion. The front image data classification portion 5c performs a pattern matching (a front image pattern matching) regarding the front image, based on a photographed data of the front part of the vehicle 7. The front photographing camera 3 obtains the photograph data of the front part of the vehicle 7 (hereinafter, referred to as a photographed data of the front part of the vehicle 7). The photographed data is obtained by image processing of the photographed image obtained by the front photographing camera 3. The front image data classification portion 5c identifies the collision status of the vehicle 7, so that the front image data classification portion 5c classifies the collision status into one of patterns stored in the pattern memory portion 5i to generate a second collision classification.

The cabin image data classification portion 5d corresponds to an occupant condition classification portion. The cabin image data classification portion 5d performs a second pattern matching based on a photographed data of the cabin of the vehicle 7. The cabin camera 4 obtains the photograph data of the cabin of the vehicle 7. The photographed data is obtained by image processing of the photographed image by the cabin camera 4. The cabin image data classification portion 5d identifies a condition of an occupant in the vehicle 7. The cabin image data classification portion 5d classifies the condition of the occupant into one of patterns stored in the pattern memory portion 5i, so that the cabin image data classification portion 5d generates an occupant condition classification.

The damage level determination portion 5e corresponds to a collision pattern determination portion. The damage level determination portion 5e performs a damage level determination based on a combination of the first collision classification generated by the acceleration data classification portion 5b and the second collision classification generated by the front image data classification portion 5c. The damage level determination portion 5e determines the damage level of the vehicle 7 into either of patterns stored in the pattern memory portion 5i. The damage level of the vehicle 7 corresponds to a collision pattern.

The vital indication level determination portion 5f corresponds to an occupant condition determination portion. The vital indication level determination portion 5f performs a vital indication level determination based on an occupant condition classification generated by the cabin image data classification portion 5d. The vital indication level determination portion 5f determines the vital indication level of each occupant in the vehicle 7 into either of the patterns stored in the pattern memory portion 5i. The vital indication level corresponds to a physical condition.

The EDR (event data recorder) portion 5g may also be referred to as a drive recorder. The EDR portion 5g corresponds to a device that video records and audio records a situation of accident of a vehicle or the like. The EDR portion 5g is generally provided to the inside of the controller 5.

The EDR portion 5g enables to record the situation for a period before a time point when an accident occurs to the vehicle 7 by a predetermined time and after a time point when the accident occurs to the vehicle 7 by a predetermined time. In other words, the EDR portion 5g enables to record the situation for a period before the time point when an accident occurs to the vehicle 7 and after the time point when the accident occurs to the vehicle 7 for a predetermined time. The EDR portion 5g in the present embodiment enables to record detection values by the acceleration sensors 2a, 2b, 5a, the front photographing camera 3, and the cabin camera 4. Incidentally, instead of providing the EDR portion 5g in the controller 5, the controller 5 may be connected to another event data recorder, which is provided outside the controller 5.

The survival rate determination portion 5h corresponds to a rescue information generation portion. The survival rate determination portion 5h performs a survival rate determination based on the damage level of the vehicle 7 generated by the damage level determination portion 5e and the vital indication level of an occupant in the vehicle 7 generated by the vital indication level determination portion 5f. The survival rate determination portion 5h generates survival rate determination information that is disposed on a two-dimensional plane according to the survival rate of each occupant. The survival rate determination information corresponds to rescue determination information. The rescue center 8 uses the survival rate determination information to select a rescue content. Incidentally, in this application, the rescue content by the rescue center may include a necessity or not of a rescue and a rescue method, for example.

The pattern memory portion 5i corresponds to a memory portion. The pattern memory portion 5i stores each pattern classified or determined by the acceleration data classification portion 5b, the front image data classification portion 5c, the damage level determination portion 5e and each level determined by the cabin image data classification portion 5d and the vital indication level determination portion 5f in advance. The patterns stored in the pattern memory portion 5i correspond to multiple damage levels, and the levels stored in the pattern memory portion 5i correspond to multiple vital indication levels.

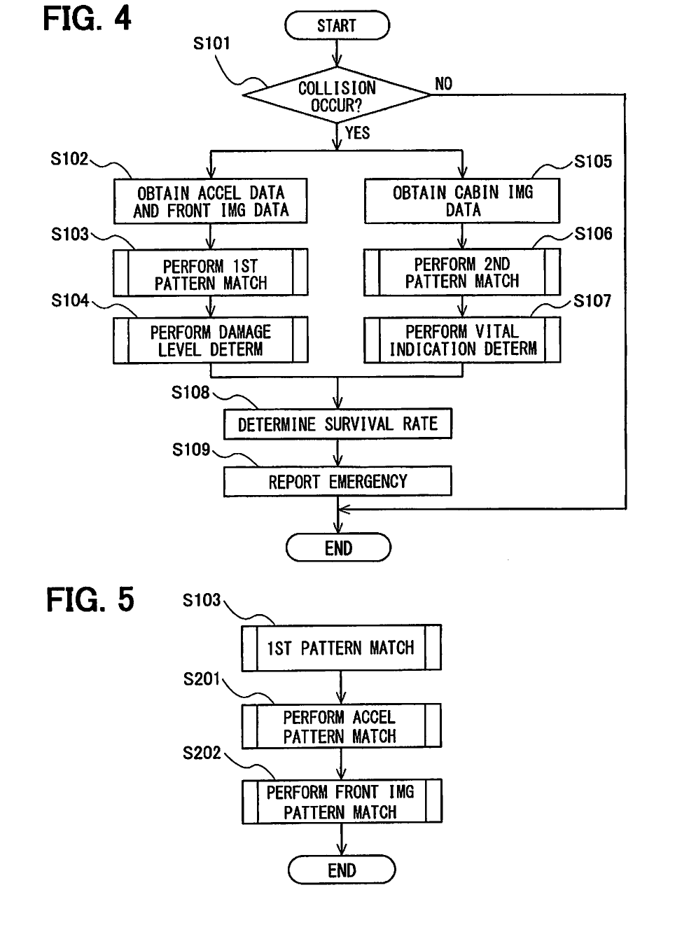

A whole flowchart of the emergency report method performed by the controller 5 will be explained with referring to FIG. 4. At S101, it is determined whether the floor acceleration sensor 5a detects acceleration greater than the first acceleration threshold GTh1, initially. When the floor acceleration sensor 5a does not detect the acceleration greater than the first acceleration threshold GTh1, the processing terminates.

When the floor acceleration sensor 5a detects the acceleration greater than the first acceleration threshold GTh1, it is determined that a collision occurs to the vehicle 7. When the collision occurs to the vehicle 7, processing at S102 and S104 and processing at S105 and S107 are performed in parallel.

At S102, the controller 5 obtains the acceleration data detected by the acceleration sensors 2a, 2b, 5a and the photographed data of the front part of the vehicle 7 photographed by the front photographing camera 3. At S103, the acceleration data classification portion 5b performs the first pattern matching based on the obtained acceleration data. The front image data classification portion 5c performs the first pattern matching based on the photographed data of the front part of the vehicle 7. At S104, based on a result of the first pattern matching, the damage level determination portion 5e performs the damage level determination. Incidentally, the first pattern matching and the damage level determination will be explained below.

At S105, the controller 5 obtains the photographed data of the cabin obtained by the cabin camera 4. At S106, based on the photographed data of the cabin, the cabin image data classification portion 5d performs a second pattern matching. At S107, based on a result of the second pattern matching, the vital indication level determination portion 5f performs the vital indication level determination. Incidentally, the second pattern matching and the vital indication level determination will be explained below.

At S108, after the damage level determination and the vital indication level determination, based on the both results, the survival rate determination portion 5h performs the survival rate determination. At S109, the communication unit 6 transmits the rescue determination information including the result of the survival rate determination to the rescue center 8.

Processing of the first pattern matching (at S103) illustrated in FIG. 4 will be explained with referring to FIG. 5 in detail. In the first pattern matching, the acceleration data classification portion 5b performs an acceleration pattern matching at S201, and then, the front image data classification portion 5c performs the front image pattern matching at S202.

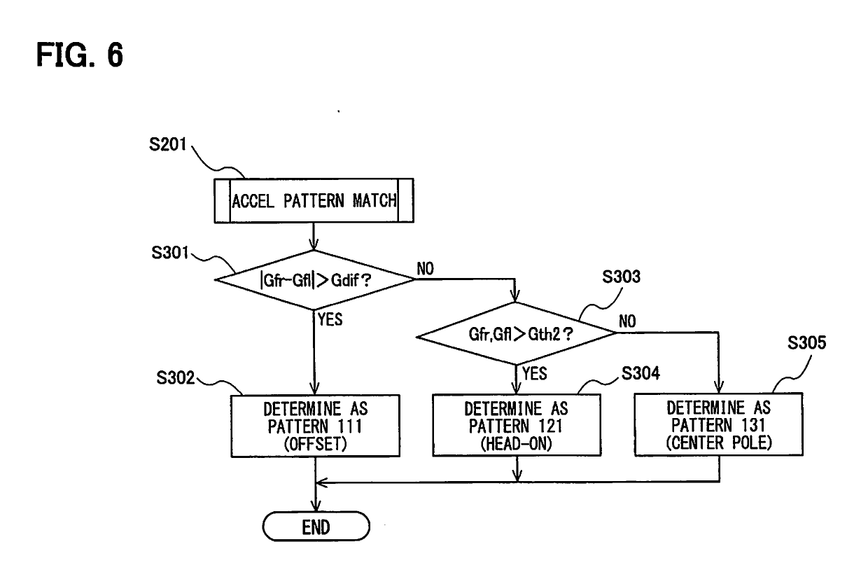

Processing in which the acceleration data classification portion 5b performs the acceleration pattern matching at S201 based on the shock applied to the vehicle 7, the shock detected by the acceleration sensors 2a, 2b, 5a, the acceleration data classification portion 5b identifies the collision status of the vehicle 7, and the acceleration data classification portion 5b generates the first collision classification will be explained with referring to FIG. 6.

At S301, it is determined whether a difference between a detection value Gfr detected by the right front acceleration sensor 2a and a detection value Gfl detected by the left front acceleration sensor 2b is greater than a shock difference threshold Gdif. When the difference between the detection value Gfr detected by the right front acceleration sensor 2a and the detection value Gfl detected by the left front acceleration sensor 2b is greater than the shock difference threshold Gdif, it is determined that the offset collision occurs to the vehicle 7 (corresponding to a pattern 111 at S302).

When the difference between the detection value Gfr detected by the right front acceleration sensor 2a and the detection value Gfl detected by the left front acceleration sensor 2b is equal to or less than the shock difference threshold Gdif, it is determined at S303 whether the acceleration greater than the second acceleration threshold GTh2 is detected in both of the right front acceleration sensor 2a and the left front acceleration sensor 2b. When the acceleration greater than the second acceleration threshold GTh2 is detected in both of the right front acceleration sensor 2a and the left front acceleration sensor 2b, it is determined that the head-on collision occurs to the vehicle 7 (corresponding to a pattern 121 at S304). When at least one of detection values Gfr, Gfl of the right front acceleration sensor 2a and the left front acceleration sensor 2b is equal to or less than the second acceleration threshold GTh2, it is determined that the vehicle 7 has a center pole collision or a road pylon collision (corresponding to a pattern 131 at S305). Incidentally, the pattern 111, the pattern 121, and the pattern 131 correspond to the first collision classification.

The pattern 111, the pattern 121, and the pattern 131 and each establishment condition are stored to the pattern memory portion 5i in advance.

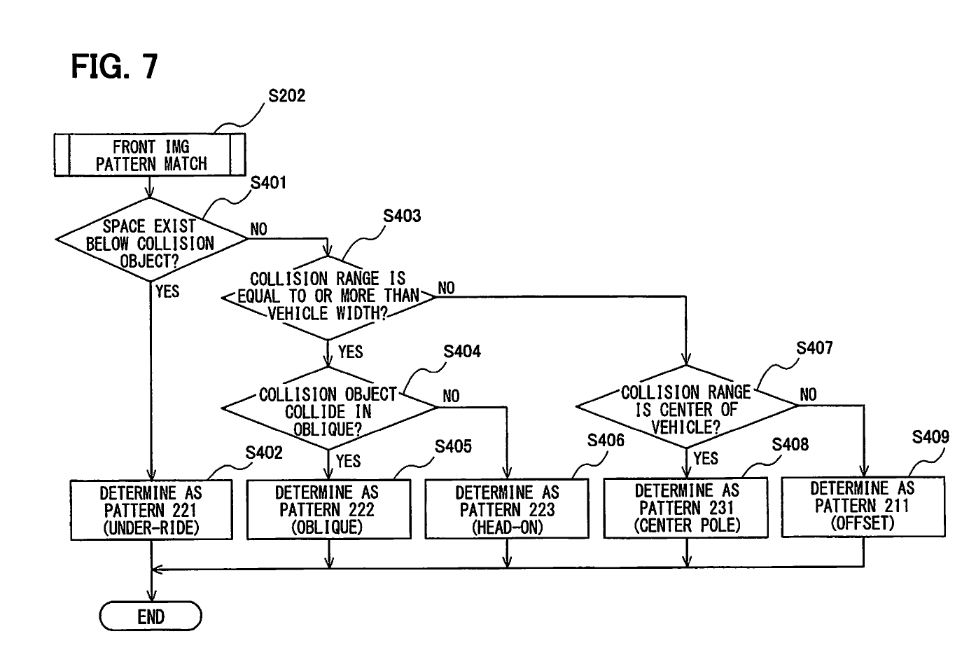

A processing in which the front image data classification portion 5c performs the front image pattern matching at S202 based on the photographed data of the front part of the vehicle 7 obtained by the front photographing camera 3, identifies the collision status of the vehicle 7, and generates the second collision classification will be explained with referring to FIG. 7.

At S401, it is determined whether a space of a predetermined area or more exists below a collision object that the front part of the vehicle 7 collides with. When the space of the predetermined area or more exists below the collision object, it is determined that an under-ride collision occurs (corresponding to a pattern 221 at S402). In the under-ride collision, the vehicle 7 gets into under the collision object. In the under-ride collision, the vehicle 7 is caught between the collision object and a road surface, for example. When the space of the predetermined area or more does not exist below the collision object, it is determined whether a collision range is equal to or more than a vehicle width of the front part of the vehicle 7 at S403. When the collision range is equal to or more than the vehicle width of the front part of the vehicle 7, it is determined at S404 whether the collision object collides with the vehicle 7 in an oblique direction. When the collision object has collided with the vehicle 7 in the oblique direction, it is determined that an oblique collision occurs to the vehicle 7 (corresponding to a pattern 222 at S405). When the collision object does not collide with the vehicle 7 in the oblique direction, it is determined that the head-on collision occurs to the vehicle 7 (corresponding to a pattern 223 at S406).

At S403, when it is determined that the collision range is less than the vehicle width of the front part of the vehicle 7, it is determined at S407 whether the collision range corresponds to a center in the right-left direction of the vehicle 7. When the collision range corresponds to the center of the right-left direction of the vehicle 7, it is determined that the center pole collision occurs to the vehicle 7 (corresponding to a pattern 231 at S408). When the collision range does not correspond to the center of the right-left direction, it is determined that the offset collision occurs to the vehicle 7 (corresponding to a pattern 211 at S409). Incidentally, the pattern 221, the pattern 222, the pattern 223, the pattern 231, and the pattern 211 correspond to the second collision classification.

The pattern 221, the pattern 222, the pattern 223, the pattern 231, and the pattern 211 and each establishment condition are stored to the pattern memory portion 5i in advance.

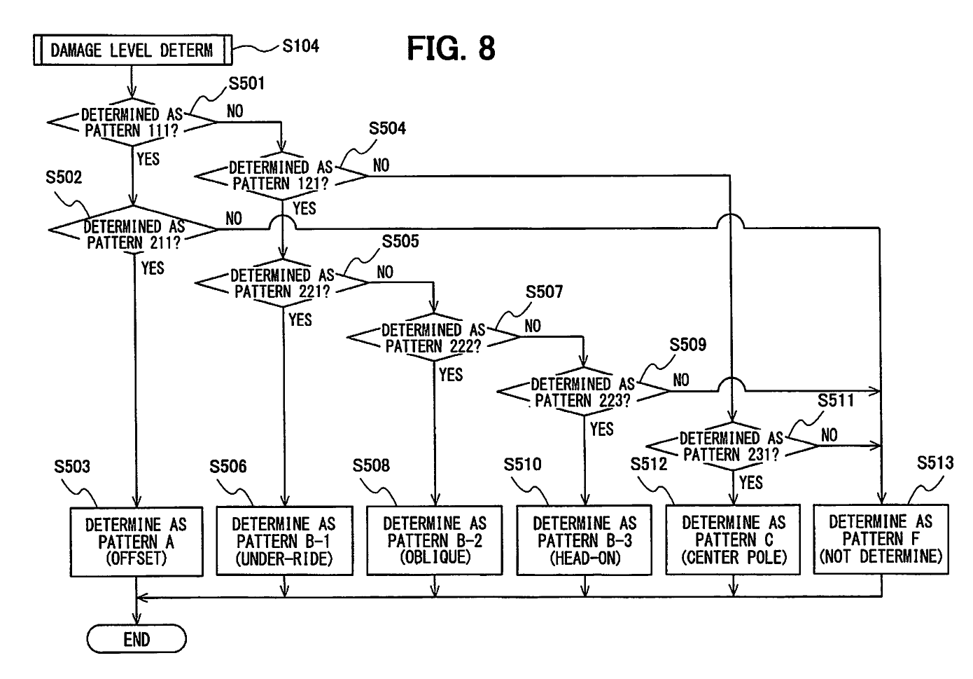

Processing in which the damage level determination portion 5e performs the damage level determination at S104 based on a combination of the first collision classification generated by the acceleration data classification portion 5b and the second collision classification generated by the front image data classification portion 5c, and determines the damage level (a collision pattern) in the vehicle 7 will be explained with referring to FIG. 8.

At S501, it is determined whether the first collision classification generated by the acceleration data classification portion 5b corresponds to the pattern 111. When the first collision classification corresponds to the pattern 111, it is determined at S502 whether the second collision classification generated by the front image data classification portion 5c corresponds to the pattern 211. When the second collision classification corresponds to the pattern 211, it is determined that the damage level corresponds to a pattern A (corresponding to an offset collision at S503). When the second collision classification does not correspond to the pattern 211, it is determined that the damage level corresponds to a pattern F (corresponding to a case where the collision pattern does not determined at S513).

When it is determined at S501 that the first collision classification does not correspond to the pattern 111, it is determined at S504 whether the first collision classification corresponds to the pattern 121. When the first collision classification corresponds to the pattern 121, it is determined at S505 whether the second collision classification corresponds to the pattern 221. When the second collision classification corresponds to the pattern 221, it is determined that the damage level corresponds to a pattern B-1 (corresponding to an under-ride collision at S506). When the second collision classification does not correspond to the pattern 221, it is determined at S507 whether the second collision classification corresponds to the pattern 222. When the second collision classification corresponds to the pattern 222, it is determined that the damage level corresponds to a pattern B-2 (corresponding to an oblique collision at S508). When the second collision classification does not correspond to the pattern 222, it is determined at S509 whether the second collision classification corresponds to the pattern 223. When the second collision classification corresponds to the pattern 223, it is determined that the damage level corresponds to a pattern B-3 (corresponding to a head-on collision at S510). When the second collision classification does not correspond to the pattern 223, it is determined that the damage level corresponds to a pattern F (corresponding to a case where the collision pattern does not determined at S513).

When it is determined at S504 that the first collision classification does not correspond to the pattern 121, it is determined at S511 whether the second collision classification corresponds to the pattern 231. When the second collision classification corresponds to the pattern 231, it is determined that the damage level corresponds to a pattern C (corresponding to a center pole collision at S512). When the second collision classification does not correspond to the pattern 231, it is determined that the damage level corresponds to a pattern F (corresponding to a case where the collision pattern does not determined at S513).

The pattern A, the pattern B-1, the pattern B-2, the pattern B-3, the pattern C, and the pattern F and each establishment condition are stored to the pattern memory portion 5i in advance.

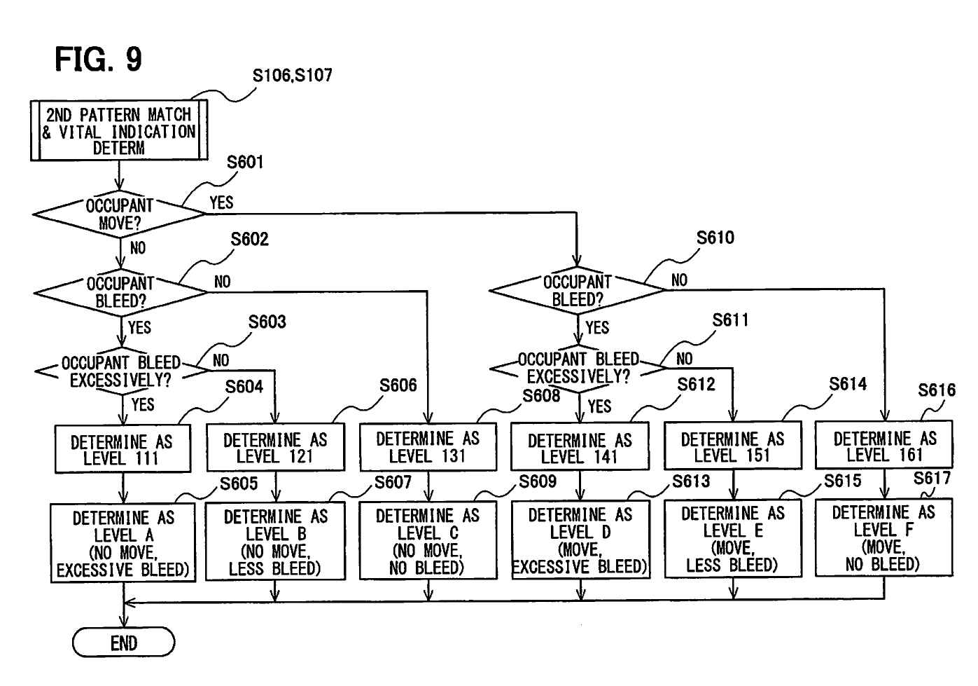

A processing in which the cabin image data classification portion 5d performs the second pattern matching at S106 based on the photographed data of the cabin obtained by the cabin camera 4 and generates the occupant condition classification identifying the condition of the occupant in the vehicle 7 and a processing in which the vital indication level determination portion 5f performs the vital indication level determination at S107 of the occupant in the vehicle 7 based on the occupant condition classification generated by the cabin image data classification portion 5d and determines the vital indication level (the physical condition) of the occupant in the vehicle 7 will be explained with referring to FIG. 9. Incidentally, the second pattern matching performed by the cabin image data classification portion 5d and the vital indication level determination performed by the vital indication level determination portion 5f are executed each occupant in the vehicle 7.

At S601, based on the photographed data of the cabin photographed by the cabin camera 4, it is determined whether an occupant in the vehicle 7 moves or not. When the occupant does not move, it is determined at S602 whether the occupant bleeds or not. When the occupant bleeds, it is determined at S603 whether the occupant bleeds excessively. When the occupant bleeds excessively, it is determined at S604 that the occupant condition classification corresponds to a level 111. When the occupant bleeds but does not bleed excessively, it is determined at S606 that the occupant condition classification corresponds to a level 121. When it is determined at S602 that the occupant does not bleed, it is determined at S608 that the occupant condition classification corresponds to a level 131.

When it is determined at S601 that the occupant moves, it is determined at S610 whether the occupant bleeds. When the occupant bleeds, it is determined at S611 whether the occupant bleeds excessively. When the occupant bleeds excessively, it is determined at S612 that the occupant condition classification corresponds to a level 141. When the occupant bleeds but does not bleed excessively, it is determined at S614 that the occupant condition classification corresponds to a level 151. When it is determined at S610 that the occupant does not bleed, it is determined at S616 that the occupant condition classification corresponds to a level 161.

The level 111, the level 121, the level 131, the level 141, the level 151 and the level 161, and each establishment condition are stored by pattern memory portion 5i in advance.

When the cabin image data classification portion 5d generates the occupant condition classification, the vital indication level determination portion 5f determines the vital indication level based on the generated occupant condition classification. As illustrated in FIG. 9, when the occupant condition classification corresponds to the level 111, the vital indication level is determined as the level A at S605. When the occupant condition classification corresponds to the level 121, the vital indication level is determined as the level B at S607. When the occupant condition classification corresponds to the level 131, the vital indication level is determined as the level C at S609. When the occupant condition classification corresponds to the level 141, the vital indication level is determined as the level D at S613. When the occupant condition classification corresponds to the level 151, the vital indication level is determined as the level E at S615. When the occupant condition classification corresponds to the level 161, the vital indication level is determined as the level F at S617.

The level A, the level B, the level C, the level D, the level E and the level F, and each establishment condition are stored by pattern memory portion 5i in advance.

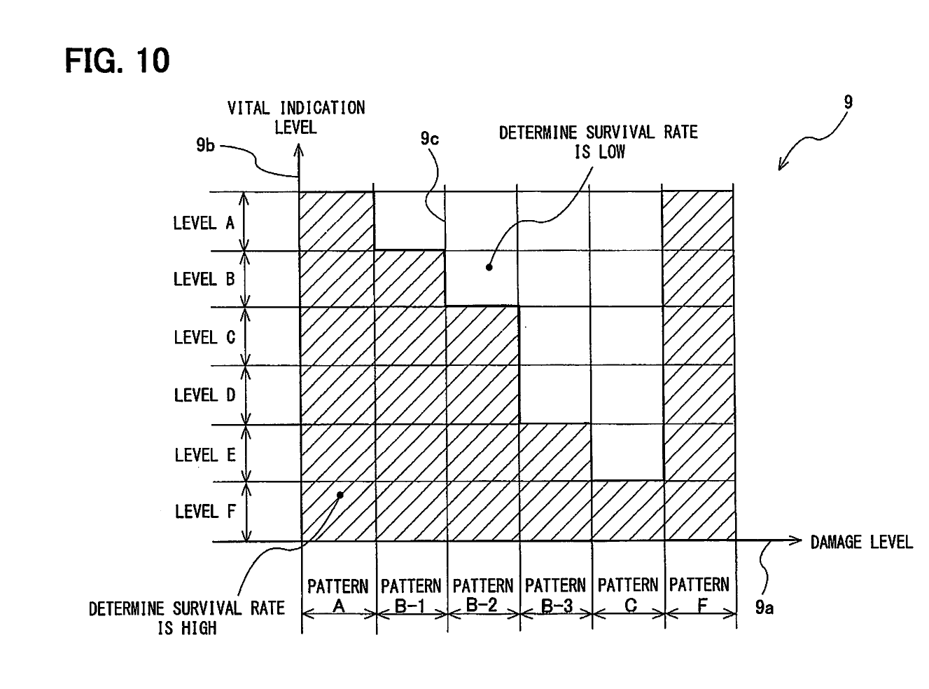

The survival rate determination information will be explained with referring FIG. 10. The survival rate determination portion 5h performs a survival rate determination and generates the survival rate determination information based on the damage level and the vital indication level. Incidentally, the damage level determination portion 5e generates the damage level of the vehicle 7. The vital indication level determination portion 5f determines the vital indication level of an occupant in the vehicle 7. The rescue center 8 uses the survival rate determination information to select a rescue method or a rescue content.

As illustrated in FIG. 10, multiple damage levels in the vehicle 7 are disposed on a horizontal axis 9a (corresponding to a first axis) on the two-dimensional plane. In addition, multiple vital indication levels of an occupant in the vehicle 7 are disposed on a vertical axis 9b (corresponding to a second axis) on the two-dimensional plane. In addition, a matrix 9 with multiple frames 9c is configured from the multiple damage levels and the multiple vital indication levels. Incidentally, in FIG. 10, the vital indication levels of the occupant in the vehicle 7 may be placed on the horizontal axis 9a on the two-dimensional plane, and the damage levels may be placed on the vertical axis 9b on the two-dimensional plane.

The survival rate determination portion 5h generates the survival rate determination information on the two-dimensional plane based on the damage level of the vehicle 7 and the vital indication level of the occupant in the vehicle 7 placed on the two-dimensional plane. Specifically, a frame 9c of each occupant is calculated and a set of the frames 9c generates the survival rate determination information. The frame 9c is a position at which the damage level on the horizontal axis 9a selected by the damage level determination portion 5e and the vital indication level on the vertical axis 9b selected by the vital indication level determination portion 5f intersect. Hereinafter, a survival rate determination result of each occupant is defined as follows. The survival rate determination result is a position where the damage level of the vehicle 7 on the horizontal axis 9a and the vital indication level of an occupant in the vehicle 7 on the vertical axis 9b intersect or a frame 9c placed at the position. Incidentally, the damage level and the vital indication level are specified for each occupant in the vehicle 7.

As illustrated in FIG. 10, a hatched region of the matrix 9 represents a region where a survival rate is high. In the hatched region, it is assumed, regarding the occupant whose survival rate determination result is included in the hatched region, that the survival rate of the occupant is high. A region other than the hatched region in the matrix 9 represents a region where the survival rate is low. In the region other than the hatched region, it is assumed, regarding an occupant whose survival rate determination result is included in this region, that the survival rate of the occupant is low.

When the survival rate determination portion 5h generates the survival rate determination information, the communication unit 6 transmits the survival rate determination information to the rescue center 8. The survival rate determination information transmitted to the rescue center 8 may include information indicating a position of the frame 9c in the matrix 9 for each occupant in the vehicle 7, and may include information indicating the survival rate is high or low for each occupant. The survival rate determination information may include information indicating the number of occupants for each position of the frame 9c in the matrix 9. The survival rate determination information may include information indicating the number of occupants whose survival rate is high and information indicating the number of occupants whose survival rate is low. The rescue center 8 uses the transmitted survival rate determination information to select a rescue method.

According to the present embodiment, the survival rate determination portion 5h generates the survival rate determination information based on a combination of the determined damage level of the vehicle 7 and the determined vital indication level of the occupant in the vehicle 7. Accordingly, it may be possible to increase amount of information regarding injury of the occupant or the like in the survival rate determination information to be transmitted. Therefore, at the time of the collision of the vehicle 7, it may be possible to beforehand consider a more specific rescue method in the rescue center 8.

The survival rate determination portion 5h disposes the determined damage level of the vehicle 7 on the first axis 9a on the two-dimensional plane, and disposes the determined vital indication level of the occupant in the vehicle 7 on the second axis 9b. The survival rate determination portion 5h generates the survival rate determination information on the two-dimensional plane based on a combination of the disposed positions of the damage level 7 in the vehicle 7 and the placed position of the vital indication level of an occupant in the vehicle 7. Thus, it may be possible to further increase amount of information regarding the injury of the occupant or the like in the survival rate determination information to be transmitted.

Since the survival rate determination information is generated on the two-dimensional plane, it may be possible for the rescue center 8 having obtained the survival rate determination information to easily recognize a situation regarding the content of the survival rate determination information.

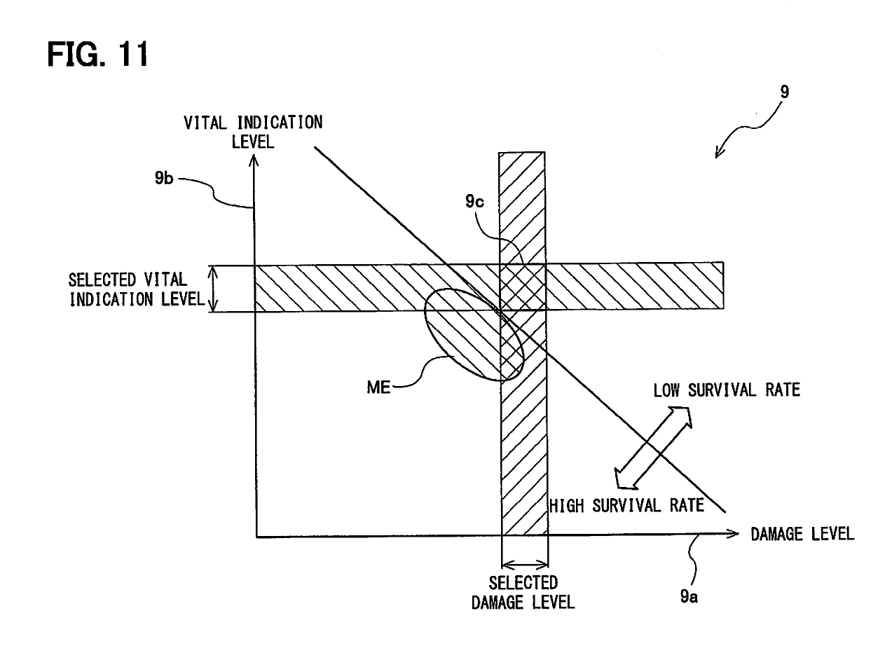

In addition, on the two-dimensional plane, the multiple damage levels and the vital indication levels placed on the axes 9a, 9b generate the matrix 9 with multiple frames 9c. The survival rate determination information is determined based on a frame 9c at which the selected damage level and the selected vital indication level intersect (referring to FIG. 11). Accordingly, a position on the two-dimensional plane is made clear in the vital rate determination information, and it may be possible to easily recognize the position on the two-dimensional plane. Therefore, in a case of a collision of a vehicle, it may be possible to take an rescue measure in the rescue center 8 more quickly.

In addition, it may be estimated that an occupant included in a region ME in FIG. 11, according to the survival rate determination result, is an occupant who may survive with a quick rescue. Therefore, it may be possible to select a rescue measure in which the occupant who may survive with a quick rescue is rescued preferentially.

Since the survival rate determination information is generated based on a combination of the damage level of the vehicle 7 and the vital indication level of the occupant in the vehicle 7, it may be possible to recognize a situation of the occupant after collision more properly compared with a case where either one of the damage level and the vital indication level is used.

The vehicular emergency report apparatus 1 includes acceleration sensors 2a, 2b, 5a that detect a shock applied to the vehicle 7 from the outside of the vehicle 7. The acceleration sensors 2a, 2b, 5a correspond to a collision status detection portion. The controller 5 includes the acceleration data classification portion 5b that generates the first collision classification, which is obtained by identifying the collision status of the vehicle 7, based on the shock applied to the vehicle 7. The damage level determination portion 5e determines the collision pattern of the vehicle 7 based on the first collision classification generated by the acceleration data classification portion 5b. According to the shock that the vehicle 7 has received, it may be possible to determine the collision pattern of the vehicle 7 exactly.

The vehicular emergency report apparatus 1 includes the right front acceleration sensor 2a and the left front acceleration sensor 2b. The acceleration data classification portion 5b determines as the offset collision in a case where the difference between detection values of the right front acceleration sensor 2a and the left front acceleration sensor 2b exceeds a predetermined value in the acceleration pattern matching. In a case where both of the detection values of the right front acceleration sensor 2a and the left front acceleration sensor 2b exceed a predetermined value, the acceleration data classification portion 5b determines as the head-on collision. In a case other than the above cases, the acceleration data classification portion 5b determines as the center pole collision. Accordingly, it may be possible to determine each collision pattern exactly based on a pattern of the shock applied to the vehicle from the outside.

The vehicular emergency report apparatus 1 includes the front photographing camera 3 as the collision status detection portion. The front photographing camera 3 photographs the front part of the vehicle 7. The controller 5 includes the front image data classification portion 5c that generates the second collision classification, which is obtained by identifying the collision status of the vehicle 7, based on the photographed data of the front part of the vehicle 7, which has been photographed by the front photographing camera 3. The damage level determination portion 5e determines the collision pattern of the vehicle 7 based on the second collision classification that has been generated by the front image data classification portion 5c. Accordingly, it may be possible to determine the collision pattern of the vehicle 7 exactly based on the image regarding the collision object that the vehicle 7 collides with.

The damage level determination portion 5e determines the collision pattern of the vehicle 7 based on a combination of the first collision classification generated by the acceleration data classification portion 5b and the second collision classification generated by the front image data classification portion 5c. Accordingly, it may be possible to segmentalize the classification of the collision pattern based on the shock received by the vehicle 7 and the image regarding the collision object that the vehicle 7 collides with. It may be possible to further improve a reliability of the determination of the collision pattern of the vehicle 7.

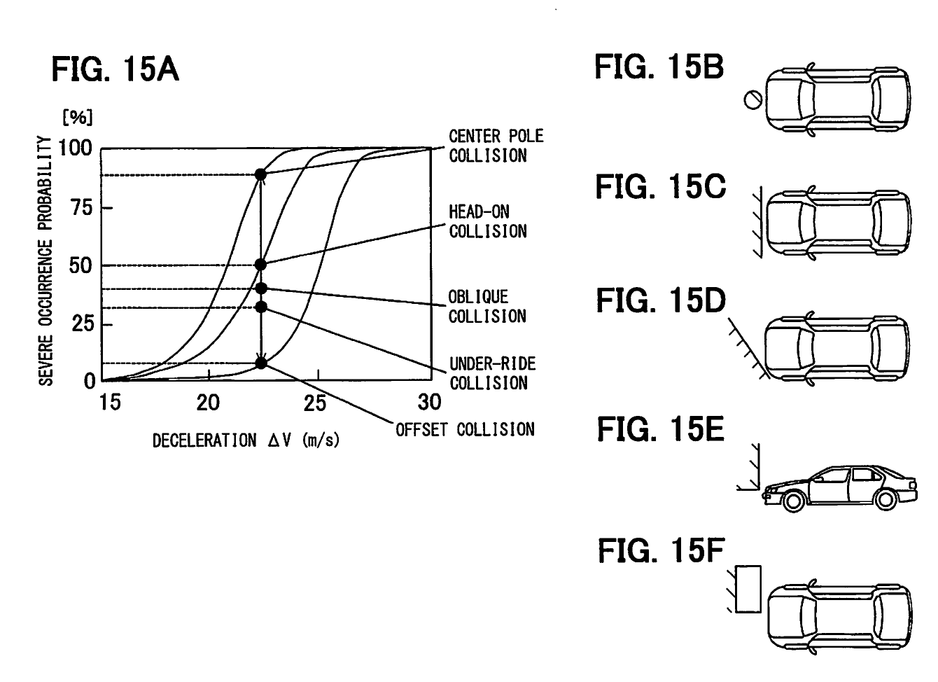

Since the collision pattern detected based on the image regarding the collision object is considered, it may be possible to estimate the injury of the occupant more precisely compared with a case where only the shock received by the vehicle 7 is used (referring to FIG. 15A to FIG. 15F).

The vehicular emergency report apparatus 1 includes the cabin camera 4 as an occupant condition detection portion. The cabin camera 4 photographs the cabin of the vehicle 7, that is, photographs the inside of the vehicle 7. The controller 5 includes the cabin image data classification portion 5d that generates the cabin condition classification, which is obtained by identifying the condition of the occupant in the vehicle 7, based on the photographed data of the cabin obtained by the cabin camera 4. The vital indication level determination portion 5f determines the vital indication level of the occupant in the vehicle 7 after the collision of the vehicle 7 based on the occupant condition classification, which is generated by the cabin image data classification portion 5d. Accordingly, it may be possible to determine the vital indication level of the occupant precisely based on the image regarding the condition of the occupant photographed by the cabin camera 4.

Since the rescue determination information generated by the controller 5 corresponds to the survival rate determination information of the occupant in the vehicle 7, it may be possible that the rescue center 8 specifically selects a rescue method to rescue the occupant in the vehicle 7.

Since the communication unit 6 reports a position on the two-dimensional plane in the survival rate determination information (the rescue determination information) generated by the controller 5, it may be possible that the rescue center 8 specifically recognizes damage of each occupant in the vehicle 7 in a short time.

All components of the controller 5 other than the floor acceleration sensor 5a are provided to the vehicle 7. Therefore, it may be unnecessary to provide a configuration with a function so as to generate the survival rate determination information in the rescue center 8, and therefore, it may be possible to reduce a size of an operation device in the rescue center 8. Since an operation processing for generating the survival rate determination information is completed in each vehicle 7, it may be possible to prevent a processing of generation of the survival rate determination information from being delayed when multiple collisions occur to multiple vehicles coincidentally.

### Second Embodiment

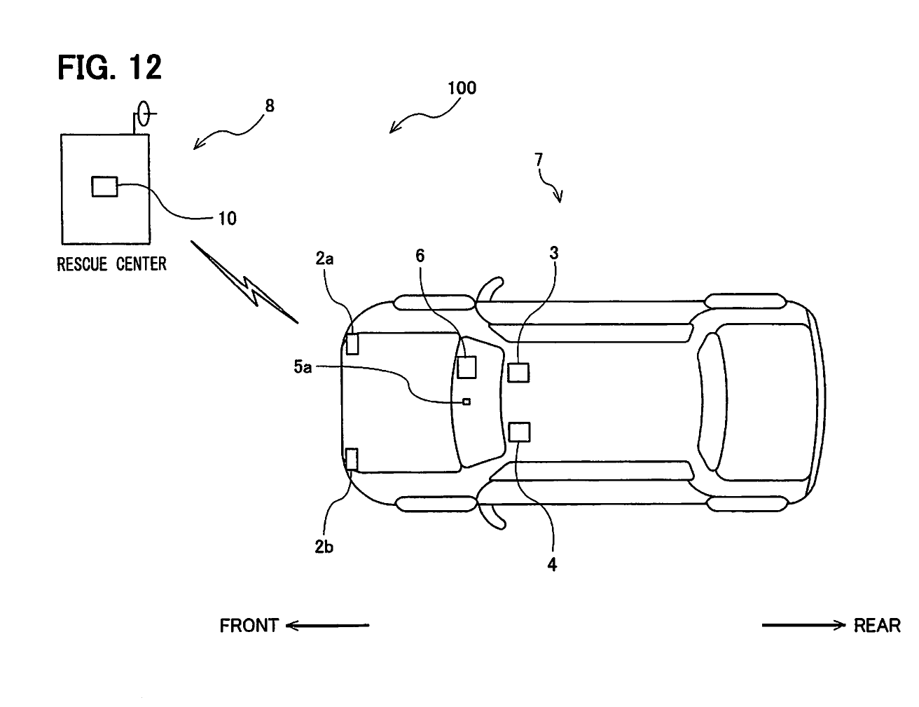

With respect to the vehicular emergency report apparatus 1 in a second embodiment, a point and configuration different from the first embodiment will be explained with referring to FIG. 12. All components of the controller 5 other than the floor acceleration sensor 5a is provided to the rescue center 8 in the vehicular emergency report apparatus 1 in the second embodiment. The all components are described as an element 10 in FIG. 12. In the present embodiment, an emergency report system 100 includes a vehicular emergency report apparatus and a rescue center.

In the vehicular emergency report apparatus 1 in the second embodiment, when an collision occurs to the vehicle 7, an acceleration data detected by the acceleration sensors 2a, 2b, 5a, a photographed data detected by the front photographing camera 3, and a photographed data detected by the cabin camera 4 are transmitted to the rescue center 8 through the communication unit 6. Then, in the controller 10 provided to the rescue center 8, the survival rate determination information is generated based on the transmitted acceleration data and the transmitted photographed data. The controller 10 in the rescue center 8 corresponds to a report control portion.

According to the second embodiment, since the all components of the controller 10 other than the floor acceleration sensor 5a is provided to the rescue center 8, it may be possible to reduce the size of an operation device in the vehicle 7 and to improve mountability of the vehicular emergency report apparatus 1 to the vehicle 7.

### Third Embodiment

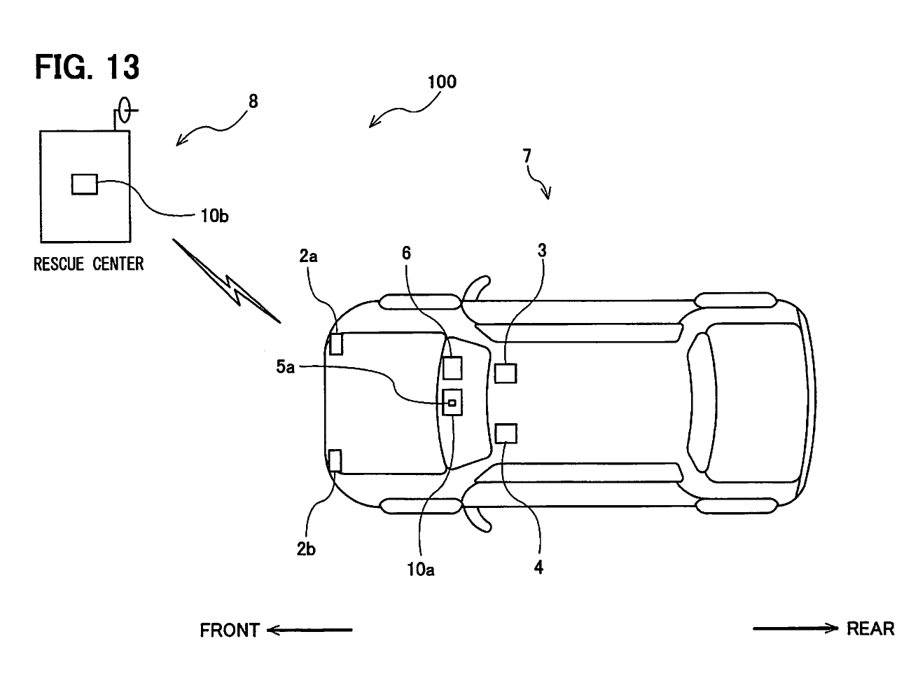

With respect to the vehicular emergency report apparatus 1 in a third embodiment, a point and configuration different from the first embodiment will be explained with referring to FIG. 13. In the vehicular emergency report apparatus 1 in the third embodiment, a part (referred to as a first controller illustrated as an element 10a in FIG. 13) of components of the controller 5 other than the floor acceleration sensor 5a is provided to the vehicle 7, and the rest part (referred to as a second controller illustrated as an element 10b in FIG. 13) of the components of the controller 5 is provided to the rescue center 8. An emergency report system 100 includes a vehicular emergency report apparatus and a rescue center.

In the vehicular emergency report apparatus 1 in the third embodiment, when the collision occurs to the vehicle 7, the first controller 10a partially performs a processing to generate the survival rate determination information. The first controller 10a corresponds to the part of the report control portion. Then, the communication unit 6 transmits a halfway result of the survival rate determination information to the rescue center 8. The survival rate determination information is generated by the first controller 10a. Then, a second controller 10b provided to the rescue center 8 completes the survival rate determination information based on the transmitted halfway result. The second controller 10b corresponds to the rest part of the report control portion.

According to the present embodiment, since the first controller 10a corresponding to a part of components of the controller 5 other than the floor acceleration sensor 5a is provided to the vehicle 7 and the second controller 10b corresponding to the rest part is provided to the rescue center 8, it may be possible to reduce the size of the operation device in the vehicle 7 and to improve a mountability of the vehicular emergency report apparatus 1 to the vehicle 7.

### Other Embodiment

It should be noted that the vehicular emergency report apparatus is not limited to the embodiments. The vehicular emergency report apparatus may be modified and/or expanded as follows.

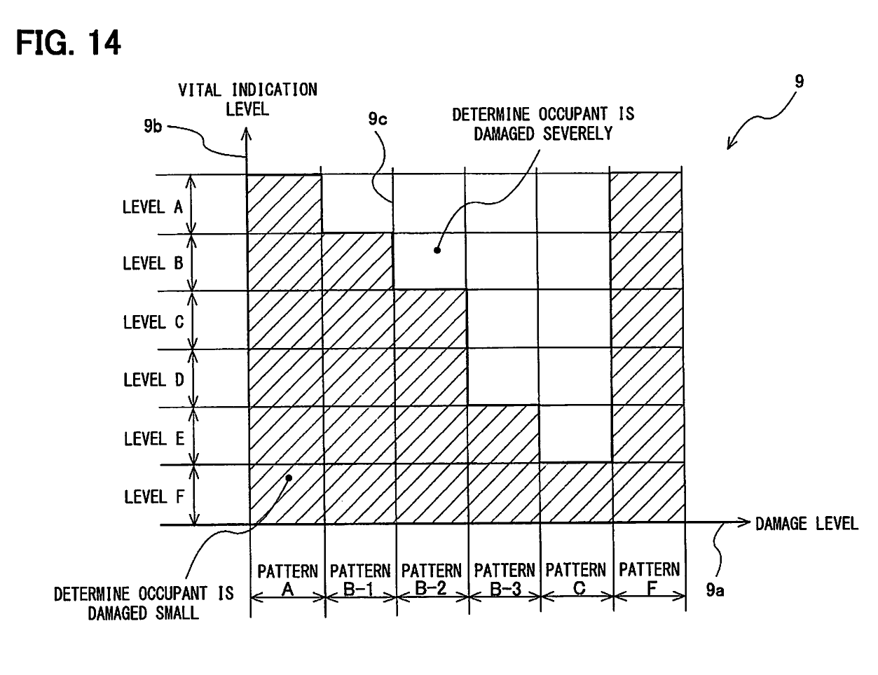

As illustrated in FIG. 14, based on a combination of the damage level and the vital indication level, the rescue determination information generated by the controller 5 may be injury condition determination information that is disposed to the two-dimensional plane according to magnitude of the injury condition that the occupant in the vehicle 7 has received. According to this configuration, it may be possible for the rescue center 8 to recognize magnitude of damage of each occupant in detail based on a position on the matrix 9 illustrated in FIG. 14.

The first pattern matching may execute either one of the acceleration pattern matching and the front image pattern matching.

The determination methods in the acceleration pattern matching illustrated in FIG. 6 and the front image pattern matching illustrated in FIG. 7 may be an example and another method different from the determination methods described in the embodiments may be performed.

When the cabin image data classification portion 5d performs the second pattern matching to generate the occupant condition classification and the vital indication level determination portion 5f performs the vital indication level determination to determine the vital indication level, a pulse sensor, a respiration sensor, a blood pressure meter, and/or a clinical thermometer may be used in addition to the cabin camera 4 or instead of the cabin camera 4. A detection value of them may be a determination index of the second pattern matching or the vital indication level.

Instead of the front photographing camera 3 and the cabin camera 4, a camera device which a driver or the like brings into the cabin from the outside such as a camera device of a mobile phone may be used.

Incidentally, the right front acceleration sensor 2a may be an example of a collision status detection portion and a shock detection portion. The left front acceleration sensor 2b may be an example of the collision status detection portion and the shock detection portion. The front photographing camera 3 may be an example of the collision status detection portion. The cabin camera 4 may be an example of an occupant condition detection potion and a cabin camera device. The controllers 5, 10 may be an example of a report control portion. The floor acceleration sensor 5a may be an example of the collision status detection portion and the shock detection portion. The acceleration data classification portion 5b may be an example of a shock classification portion. The front image data classification portion 5c may be an example of a vehicle exterior image classification portion. The cabin image data classification portion 5d may be an example of an occupant condition classification portion. The damage level determination portion 5e may be an example of a shock pattern determination portion. The vital indication level determination portion 5f may be an example of an occupant condition determination portion. The survival rate determination portion 5h may be an example of a rescue information generation portion. The pattern memory portion 5i may be an example of a memory portion. The communication unit 6 may be an example of a report portion. The horizontal axis 9a may be an example of a first axis. The vertical axis 9b may be an example of a second axis. The first axis is perpendicular to the second axis, for example. The first controller 10a may be an example of a part of the report control portion. The second controller 10b may be an example of a rest part of the report control portion. Incidentally, the part of the report control portion may be an example of a first part of the report control portion, and the rest part of the report control portion may be an example of a second part of the report control portion.

It is noted that a flowchart or a processing of the flowchart in the present application includes steps (also referred to as sections), each of which is represented, for example, as S101. Further, each step may be divided into several sub-steps, and several steps may be combined into a single step.

While the vehicular emergency report apparatus has been described with reference to embodiments thereof, it is to be understood that the disclosure is not limited to the embodiments and constructions. The vehicular emergency report apparatus is intended to cover various modification and equivalent arrangements. In addition, while the various combinations and configurations, other combinations and configurations, including more, less or only a single element, are also within the spirit and scope of the present disclosure.

What is claimed is:

1. A vehicular emergency report apparatus comprising:
a report portion reporting to a rescue center when a collision occurs to a vehicle;
a collision status detection portion detecting a collision status of the vehicle;
an occupant condition detection portion detecting a condition of an occupant in the vehicle after the collision of the vehicle; and
a report control portion,
wherein
the report control portion includes:
a memory portion that stores a plurality of collision patterns of the vehicle and a plurality of physical conditions of the occupant after the collision of the vehicle;
a collision pattern determination portion that selects a collision pattern from the plurality of collision patterns stored in the memory portion based on the collision status of the vehicle detected by the occupant condition detection portion;
an occupant condition determination portion that selects a physical condition from the plurality of physical conditions stored in the memory portion based on the condition of the occupant detected by the occupant condition detection portion; and
a rescue information generation portion that generates rescue determination information based on a combination of the collision pattern selected by the collision pattern determination portion and the physical condition selected by the occupant condition determination portion, wherein the rescue center uses the rescue determination information to select a rescue content.

2. The vehicular emergency report apparatus according to claim 1, wherein
the rescue information generation portion disposes the collision pattern selected by the collision pattern determination portion on a first axis of a two-dimensional plane,
the rescue information generation portion disposes the physical condition selected by the occupant condition determination portion on a second axis of the two-dimensional plane, and
the rescue information generation portion generates the rescue determination information on the two-dimensional plane based on a combination of the disposed collision pattern and the disposed physical condition.

3. The vehicular emergency report apparatus according to claim 1, wherein
the collision status detection portion includes a shock detection portion that detects a shock applied to the vehicle from an outside of the vehicle,
the report control portion includes a shock classification portion that generates a first collision classification based on the shock applied to the vehicle and detected by the shock detection portion, wherein the first collision classification indicates the collision status of the vehicle, and
the collision pattern determination portion selects the collision pattern of the vehicle based on the first collision classification generated by the shock classification portion.

4. The vehicular emergency report apparatus according to claim 1, wherein
the collision status detection portion includes a vehicle exterior photographing device that photographs a front part of the vehicle,
the report control portion includes a vehicle exterior image classification portion that generates a second collision classification based on a photographed data of the front part of the vehicle, which is photographed by the vehicle exterior photographing device, wherein the second collision classification indicates the collision status of the vehicle, and
the collision pattern determination portion selects the collision pattern of the vehicle based on the second collision classification generated by the vehicle exterior image classification portion.

5. The vehicular emergency report apparatus according to claim 1, wherein
the collision pattern determination portion selects the collision pattern of the vehicle based on a combination of the first collision classification, which is generated by the shock classification portion, and the second collision classification, which is generated by the vehicle exterior image classification portion.

6. The vehicular emergency report apparatus according to claim 1, wherein
the occupant condition detection portion includes a cabin camera device that photographs a cabin of the vehicle,
the report control portion includes an occupant condition classification portion that generates an occupant condition classification based on a photographed data of the cabin of the vehicle obtained by the cabin camera device, wherein the occupant condition classification indicates the condition of the occupant in the vehicle, and
the occupant condition determination portion selects the physical condition of the occupant in the vehicle after the collision of the vehicle based on the occupant condition classification generated by the occupant condition classification portion.

7. The vehicular emergency report apparatus according to claim 2, wherein
the rescue determination information generated by the report control portion is survival rate determination information that is disposed on the two-dimensional plane according to a survival rate of each occupant.

8. The vehicular emergency report apparatus according to claim 2, wherein
the rescue determination information generated by the report control portion is injury condition determination information that is disposed on the two-dimensional plane according to an injury condition of each occupant.

9. The vehicular emergency report apparatus according to claim 2, wherein
the report portion reports a position on the two-dimensional plane in the rescue determination information generated by the report control portion.

10. The vehicular emergency report apparatus according to claim 1, wherein
all components of the report control portion are provided to the vehicle, and
the report portion transmits the rescue determination information generated by the report control portion of the vehicle to the rescue center.

11. The vehicular emergency report apparatus according to claim 2, wherein
the two-dimensional plane includes a matrix,
the matrix includes a plurality of frames, which are generated according to the collision patterns and the physical conditions,
the collision patterns are disposed on the first axis of the two-dimensional plane,
the physical conditions are disposed on the second axis of the two-dimensional plane, and
the rescue determination information is determined based on one of the frames corresponding to a position where the selected collision pattern and the selected physical condition intersect.

12. An emergency report system comprising:
a rescue center;
a report portion reporting to the rescue center when a collision occurs to a vehicle;
a collision status detection portion detecting a collision status of the vehicle;
an occupant condition detection portion detecting a condition of an occupant in the vehicle after the collision of the vehicle; and
a report control portion,
wherein
the report control portion includes:
a memory portion that stores a plurality of collision patterns of the vehicle and a plurality of physical conditions of the occupant after the collision of the vehicle;
a collision pattern determination portion that selects a collision pattern from the plurality of collision patterns stored in the memory portion based on the collision status of the vehicle detected by the occupant condition detection portion;
an occupant condition determination portion that selects a physical condition from the plurality of physical conditions stored in the memory portion based on the condition of the occupant detected by the occupant condition detection portion; and
a rescue information generation portion that generates rescue determination information based on a combination of a collision pattern selected by the collision pattern determination portion and a physical condition selected by the occupant condition determination portion, wherein the rescue center uses the rescue determination information to select a rescue content.

13. The emergency report system according to claim 12, wherein
all components of the report control portion are provided to the rescue center, and
when the collision occurs to the vehicle,
the report portion transmits the collision status of the vehicle detected by the collision status detection portion and the condition of the occupant after the collision of the vehicle detected by the occupant condition detection portion to the rescue center, and
the report control portion provided to the rescue center generates the rescue determination information based on the collision status of the vehicle and the condition of the occupant, which are transmitted.

14. The emergency report system according to claim 12, wherein
the report control portion is configured from a first part of the report control portion and a second part of the report control portion,
the vehicle includes the first part of the report control portion,
the rescue center includes the second part of the report control portion, and
when the collision occurs to the vehicle,
the first part of the report control portion in the vehicle generates a halfway result of the rescue determination information,
the report portion transmits the halfway result of the rescue determination information to the rescue center, and
the second part of the report control portion in the rescue center completes the rescue determination information based on the transmitted halfway result.

15. The emergency report system according to claim 13, wherein
the vehicle includes the report portion, the collision status detection portion, and the occupant condition detection portion.

16. The emergency report system according to claim 14, wherein
the vehicle includes the report portion, the collision status detection portion, and the occupant condition detection portion.
